(19) United States
(12) Patent Application Publication
(10) Pub. No.: US 2007/0158412 A1
(43) Pub. Date: Jul. 12, 2007

(54) NON-CONTACT PAPER-BASED ELECTRONIC TICKET BASED ON ELECTRONIC TAG TECHNIQUES

(75) Inventors: Kejun KANG, Beijing (CN); Haifeng Hu, Beijing (CN); Shi WANG, Beijing (CN); Qitian MIAO, Beijing (CN); Zhiqiang CHEN, Beijing (CN)

Correspondence Address: YING CHEN, 255 S. GRAND AVE., # 215, LOS ANGELES, CA, 90012, US

(73) Assignees: TSINGHUA UNIVERSITY, Beijing (CN); NUCTECH COMPANY LIMITED, Beijing (CN)

(21) Appl. No.: 11/612,578

(22) Filed: Dec. 19, 2006

(30) Foreign Application Priority Data
Dec. 19, 2005 (CN) 200510131787.6

(51) Int. Cl. G06K 5/00; G06K 19/06

(52) U.S. Cl. 235/380; 235/382; 235/492

(57) ABSTRACT

The present invention provides an electronic ticket compatible with the existing railway paper tickets, which comprises two layers of paper media where an antenna and a chip are buried in advance and is characterized in that dynamic encryption information is written into said chip in advance and has a check code associated with a serial number for anti-counterfeiting; at a ticket selling terminal, ticket information will be written into said chip, and such ticket information in said chip can be rewritten many times; and said antenna is used for receiving RF signals and transmitting them to said chip.

### BACKGROUND OF THE INVENTION

1. Field of the Invention

The present invention relates to electronic tag RFID techniques, more particularly, to a non-contact paper-based electronic ticket based on electronic tag techniques and an Automatic Fare Collection (AFC) system thereof.

2. Description of Prior Art

Presently, railway passenger ticket system use the paper ticket, print the ticket information such as date/time, train number, seat/sleep number, price, departure/destination station. This kind of tickets exist two big disadvantages, the first, it is easy to be counterfeited, a lot of bogus tickets appears in the market and disturbs the development of the railway passenger transport; the second, manual check in, low rate and no information collection the selling—checking-in procedures of the system are in an open loop condition.

There are some solutions for solving the above problems in which magnetic strip card and electronic tag (RFID) are the most popular ones. The magnetic strip card techniques were maturely used for ticket anti-counterfeiting in 1970s with great successes. However, for current railway passenger transport, the magnetic tickets have the main problems as follows. The paper-based magnetic ticket technique can not completely overcome the defects of easy dirty and damage and thus in the current usage environment, the first-success-read rate will be reduced. Moreover, the contact check-in manner of the magnetic tickets (the tickets will pass through the machine after some mechanical motions) destines that it will have a low check-in efficiency, and it might finally have the same result as the bar code check-in manner so that the selling—checking-in procedures will still be in the open loop condition. The magnetic tickets are also poor in anti-counterfeiting, and the selling devices and the check-in devices for the magnetic tickets have complex structures and thus have higher maintenance costs.

With the Radio-Frequency IDentification (RFID) technique used for the automatic fare collection of the railway system, the domestically and internationally employed solutions mainly uses the non-contact IC card such as Octopus cards in Hongkong and Smart cards of many AFC manufacturers which can be used many times without printing ticket information. But with this manner, the passenger can not intuitively know information such as Train Number, Time and Seat Number since no ticket information is printed. Also, such as the Guangzhou-Shenzhen passenger transport dedicated line, a recycled IC card (hard card) is used with a special film coated thereon for printing the ticket information one time and another. This manner has higher technical and managing costs. The above two manners are not compatible with the existing railway ticket system and both need additionally printed invoices.

### SUMMARY OF THE INVENTION

The object of the present invention is to provide a novel ticket highly compatible with the existing ticket system, i.e., a non-contact paper-based electronic ticket, which is an expendable paper-based ticket based on electronic tag techniques, using a dedicated chip design, a printed antenna and an advanced automatic pipeline packaging process.

According to the first aspect of the present invention, an electronic ticket compatible with the existing railway paper tickets is provided, which comprises two layers of paper media where an antenna and a chip are buried in advance and is characterized in that: dynamic encryption information is written into said chip in advance and has a check code associated with a serial number for anti-counterfeiting; at a ticket selling terminal, ticket information will be written into said chip, and such ticket information in said chip can be rewritten many times; and said antenna is used for receiving RF signals and transmitting them to said chip.

According to the second aspect of the present invention, a method for producing an electronic ticket compatible with the existing railway paper tickets is provided, which comprises the steps of: printing ticket information on a first layer of paper medium; burying an antenna and a chip in a second layer of paper medium; writing dynamic encryption information in said chip in advance, and this information having a check code associated with a serial number for anti-counterfeiting; when selling the ticket, writing the ticket information into said chip, and such ticket information in said chip being able to be rewritten many times; and when checking-in, receiving by said antenna an RF signal emitted from a check-in apparatus and transmitting it to said chip to verifying the authenticity of said ticket.

The non-contact electronic ticket provided by the present invention has the following advantages superior to the other identification carriers:
1. Non-contact rapid read/write, and parallel readable. The identification distance of the electronic ticket is up to 10 cm, as compared with the bar codes, linear alignment scan is not required, and as compared with the magnetic tickets, contact is not required. With the rapid read/write speed, it can be recognized during motions. With the rapid access speed, it can simultaneously read/write a plurality of electronic tickets so as to facilitate the increase of the check-in efficiency which conforms to the large passenger traffic condition;
2. High anti-counterfeiting. The electronic tag data are encrypted and authenticated and thus can not be counterfeited;
3. High fold-damage-proof and water-resistant. When it is curved and folded, the data in the ticket can also be read out effectively (good first-success-read);
4. Economic and reliable check-in device easily maintenance without cleaning requirements. The read/write head is not exposed and thus is hardly worn and torn, and thus a lot of maintenance costs are saved. It is especially suitable for severe environments such as windy, sandy and moist ones so that it is very appropriate for the weather conditions across a large country;
5. High compatibility with the existing ticket system, and match with the existing ticket selling mechanism. The electronic tickets may also be provided in rolls so that it is unnecessary to consider the problems occurring for boxed tickets such as counting tickets. As compared with the entire ticket making and selling procedures of the past, only two steps are added, one is to package the electronic tag in the tickets in rolls before printing, and the other is to write data into the electronic tickets after printing (the printer and the write-in device can be integrated or separated, and the time duration for writing data is less than 1 second). As such, the existing ticket selling software and mechanism remain unchanged. Additionally, the existing ticket managing system is not changed.

### EFFECTS OF THE PRESENT INVENTION

As compared with other identification carriers, the non-contact electronic ticket based on electronic tag techniques has the obvious advantages, such as non-contact read/write, rapid read/write and parallel readable, which facilitate the increase of the check-in efficiency so as to conform to the large passenger traffic condition; it also has the features of high fold-damage-proof and water-moisture-resistant, so that when it is curved and folded, the data in the ticket can also be read out effectively (good first-success-read), and thus a true selling—checking-in close loop operation can be achieved; high anti-counterfeiting; economic and reliable check-in device easily maintenance without cleaning requirements so that it is very appropriate for the weather conditions across a large country. With the development of the semiconductor techniques, the price of the electronic tags has decreased to be acceptable for railway tickets, and with development of the integrated circuit techniques and the usage increase of the tickets, the cost will be further reduced. Considering the maintenance costs of the check-in devices and the entire system, the operation cost of the entire system will be further reduced. In addition to the above superiorities of high anti-counterfeiting, true selling—checking-in close loop operation, it is more important that the electronic ticket based on the electronic tag techniques can support the upgrade of the future railway system informatization.

The present invention not only uses the radio-frequency identification techniques for the upgrade of the existing railway ticket, but also emphasizes the high compatibility with the existing ticket system and ticket managing system in the specific embodiments. So, it not only has low cost and penalty without training requirements, but also facilitates the smooth transit from the old system to the new one.

Not firstly applying the transit technique—the magnetic ticket, and then transiting to the electronic tickets, but directly applying the electronic ticket using the most advanced automatic identification technique—RFID identification—into the railway fare collection system will boost the railway fare collection informatization directly up to the most advanced technical level in the world, which is inconsistent with the requirements of the government and may also avoid the costs due to the second software and hardware upgrades from the magnetic ticket to the electronic ticket.

### BRIEF DESCRIPTION OF THE DRAWINGS

The above objects, advantages and features of the present invention will be more apparent from the following detailed description about the preferred embodiments thereof referring to the attached drawings in which:

FIG. 1 is a schematic diagram of the electronic tickets in rolls (the chips and the antennas are packaged in the paper tickets in advance and the tickets are supplied in rolls as before);

FIG. 2 is a schematic diagram of one electronic ticket (the chip and the antenna are buried in the paper ticket in advance);

FIG. 3 shows an electronic ticket machine adopted from a prior art ticket machine with a radio-frequency read/write module added-in;

FIG. 4 shows the packaging flow of the electronic tickets;

FIG. 5 shows the operating principle of the electronic tags;

FIG. 6 shows the ticket making and selling flow of the electronic tickets.

### DETAILED DESCRIPTION OF PREFERRED EMBODIMENTS

Next, the preferred embodiments of the present invention will be described referring to the drawings.

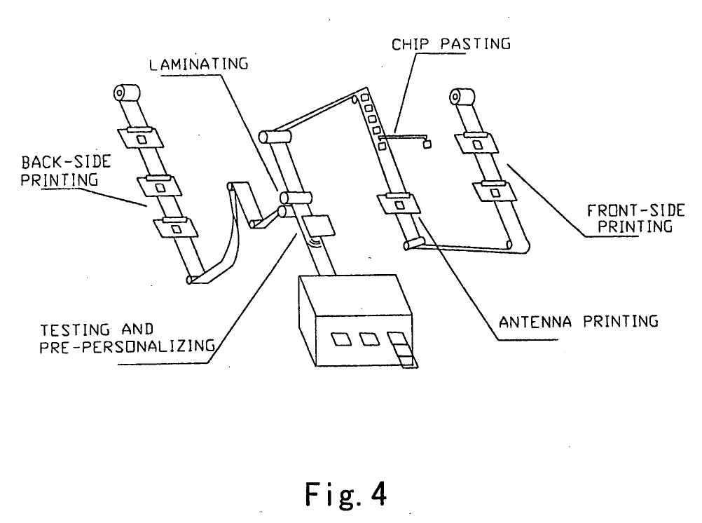

FIG. 1 is a schematic diagram of the electronic tickets in rolls. As shown in FIG. 1, the electronic tickets 11 in rolls according to the present invention are based on and improve the tickets in rolls according to the prior art with the chips and the antennas packaged therein in advance. In the ticket manufacture factory, an electronic tag packaging pipeline is used for packaging the chips and the antennas into the manufactured tickets in rolls, in which the printing and packaging may be simultaneously performed on the packaging pipeline. Referring to FIG. 4, the appearance of the packaged tickets in rolls is the same as that of the common used tickets in rolls.

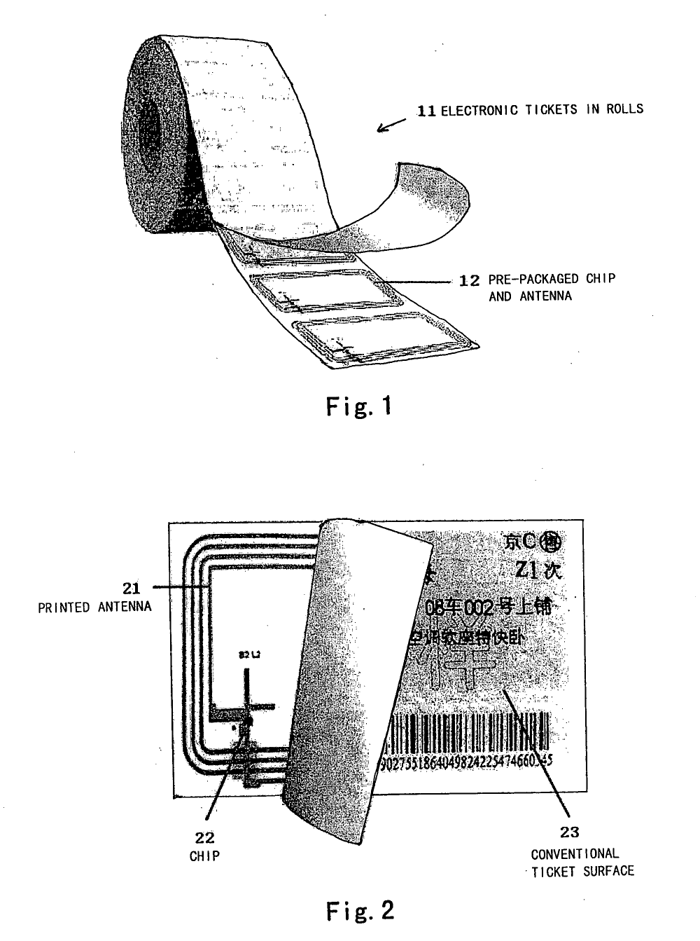

FIG. 2 is a schematic diagram of one electronic ticket. As shown in FIG. 2, one electronic ticket cut from the electronic tickets in rolls shown in FIG. 1 is illustrated. A chip and an antenna are buried in the paper-based ticket in advance. As shown in FIG. 2, 21 denotes the printed antenna which can be made with conductive ink; 22 is the chip according to the present invention which can be dedicatedly designed according to the operator's requirements and has a high security and a low cost, and in this chip, dynamic encryption information is written and has a check code associated with a serial number for anti-counterfeiting, and a check-in bit is provided in the data stored in said chip for preventing multiple check-in; 23 is conventional ticket information. The ticket information of the electronic ticket according to the present invention may remain as same as the conventional ticket information, or may be changed according to special requirements, such as adding English information and arrival time or deleting the bar code.

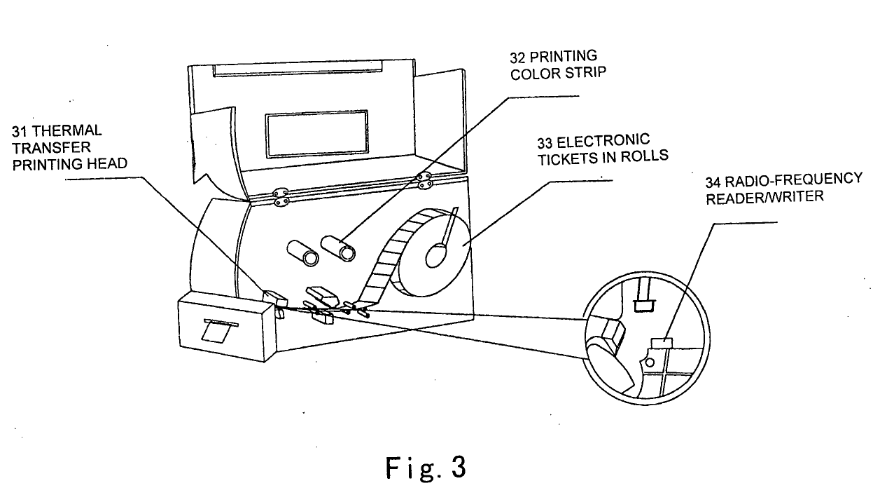

FIG. 3 shows an electronic ticket machine according to the present invention adopted from a prior art ticket machine. Referring to FIG. 3, the electronic ticket machine according to the present invention comprises: a thermal transfer printing head 31 which is the same as that in the conventional ticket machine, a printing color strip 32, electronic tickets 33 in rolls as shown in FIG. 1, and a radio-frequency reader/writer with its antenna 34. The electronic ticket machine according to the present invention as shown in FIG. 3 adds a radio-frequency read/write module into the conventional ticket machine, and as compared with other ticket making modules such as for the magnetic tickets, the radio-frequency read/write module has a significantly reduced cost.

FIG. 4 shows the packaging flow of the electronic tickets. The electronic tickets according to the present invention are produced with a high-speed automatic process line, a high-speed automatic processing procedure and a mass production pipeline. Each process line may produce 10 tickets per second which results in an annual production of 100 million tickets. The detailed packaging is shown in FIG. 4. As shown in FIG. 4, the electronic tickets according to the present invention comprise two layers of paper media. Firstly, ticket back-side information is printed on one layer, and at the same time, ticket front-side information is printed on the other layer and also on this layer, an antenna formed with the conductive ink is printed, and after the printing of the antenna, a memory chip is then pasted thereon. After the respective printings of the above two layers, the two layers of paper media with the printed ticket front-side and back-side information and packaged antenna and chip are laminated together. Thereafter, the packaged tickets are tested and written with corresponding information. Finally, the tickets are rolled in rolls.

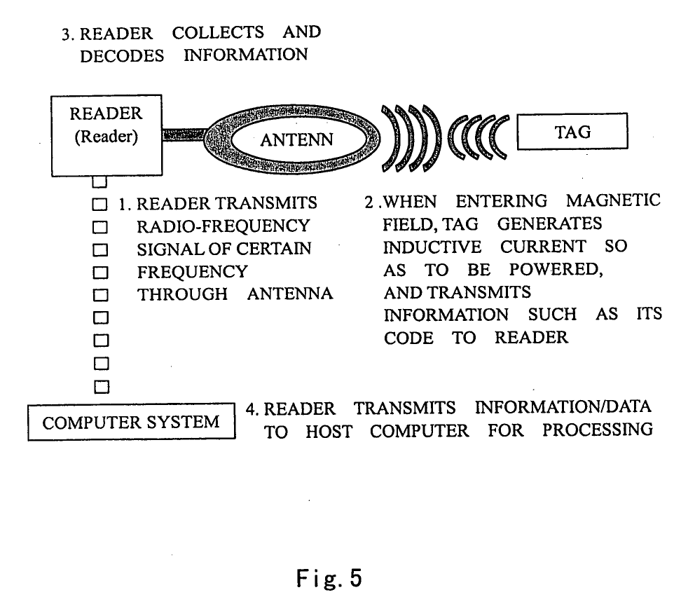

FIG. 5 shows the operating principle of the electronic tags. Next, the operating principle of the electronic tags will be described with reference to FIG. 5.

Firstly, the electronic tags are schematically described. The electronic tags are also referred to as smart tags, tags or smart labels. The kernel is a chip which uses the Radio-Frequency IDentification RFID techniques and has a certain storage capacity.

The features of the electronic tags are as follows:
Passive long-distance read/write
Conflicting-proof techniques: as compared with the bar code, it does not need the linear aligned scanning, has rapid read/write speed, and may be identified for multiple targets and in motions, and up to 30 may be identified per seconds.
International unified frequency: 13.56 MHz±7 kHz
Flexible internal storage space: The manufacturers may define storage capacities and the number of bytes for each sector of various products according to their respective requirements, and the reader/writer device may read memory configuration information for facilitating the operation of different tag products in one comprehensive application.
International unified and non-repeated 8 bytes (64 bits) Unique IDentifier (abbreviated as UID), in which 1-48 bits (6 bytes) are the product code of the manufacturer, 49-56 bits (1 byte) are the manufacturer code (ISO/IEC7816-6/AM1), and the most significant byte is “E0”.
Re-readable/re-writable and the sector able to be independently locked once: the existing products generally use 4-bytes sector, and the capacity varies from 512 bits-2048 bits.
Long lifetime: no mechanic wearing and tearing, no mechanic failure, able to be used in severe environments (operating temperature: −25° C.-+70° C.).

Referring to FIG. 5, a typical RFID system is composed of an electronic tag (Tag), a reader/writer, a data exchanging and managing system and the like. The electronic tag is also referred to as a radio-frequency card and has the capabilities of smart read/write and encrypted communication. The reader/writer is composed of a radio transceiver module, an antenna, a control module, an interface circuit and the like. There is no battery in the electronic tag, and the power of the electronic tag is provided by radio-frequency pulses emitted from the reader/writer. The electronic tag demodulates data from the received radio-frequency pulses, and transmits them to the control logic. The control logic accepts the instructions for performing storage, data transmission or other operations. EEPROM is used for storing ID number of the electronic tag and other user data. In FIG. 5, the reader firstly transmits a radio-frequency signal of a certain frequency through the antenna. When a tag enters into the magnetic field, it generates an inductive current so as to be powered and transmits information such as its code to the reader. The reader collects and decodes the information, and then transmits the decoded information/data to a host computer for processing.

The features of the novel non-contact paper-based electronic ticket based on electronic tag techniques according to the present invention are as follows:
Dedicated chip design
The electronic ticket will use the dedicated chip design. The memory spaces for storing keys and transaction records are saved to lower the cost of the ticket or card and to increase the transaction speed.
The electronic ticket according to the present invention designs rapid card read/write instructions for the applications. One normal card transaction takes no more than 100 ms.
The electronic ticket according to the present invention employs a 32-bits serial number uniquely in the world in which a chip manufacturer code, a producer code and an application code are stored. The above information can not be changed after the card is transferred to individuals, for anti-counterfeiting. Properly written data will have a check code associated with the serial number, and when the card is read, the check code can be checked with an SAM or system. The keys and algorithms for generating the check code and for checking the check code may be distributed in different parts of the system. The check algorithm can be a standard 3DES algorithm or a check algorithm newly designed by the railway department for ensuring the system security.
printed antenna
In the electronic ticket according to the present invention, the antenna is printed on the paper media with the conductive ink, which is environment-friendly, economical and reliable.
Such antenna printing manner enables the mass, high-speed, continuous production; and at the same time, the antenna itself has a good extensity, conductivity, anti-oxidation, fold-nip-proof and the like.
Paper ticket card
The electronic ticket according to the present invention has a lower price and can be incorporated with various paper documents. It is high-temperature-resistant, fold-proof and environment-friendly; and easily cut. The lifetime thereof can be extended by coating with plastic films or being made from plastics, for preventing tearing-off, friction, moisture and deformation. It can be disposable/recyclable, repeatedly read/written, and printed with a standard printer. For advertisements, it can provide a card area as large as possible, and according to different requirements, it can be customized into any sizes and corresponding materials. The materials can be PVC/PET→paper, and etched or embedded copper antenna→printed antenna, the processing procedure can be conventional single or imposition→continuous production, and the chip therein can be dedicatedly designed with a size as small as possible and a memory capacity as small as possible.
High-speed automatic process line
A high-speed automatic processing procedure and a mass production pipeline: each process line may produce 10 tickets per second which results in an annual production of 100 million tickets.
The connection between the antenna and the chip is performed in a computer controlled mechanic adhesive manner without any soldered point. The patterns are printed before laminating.

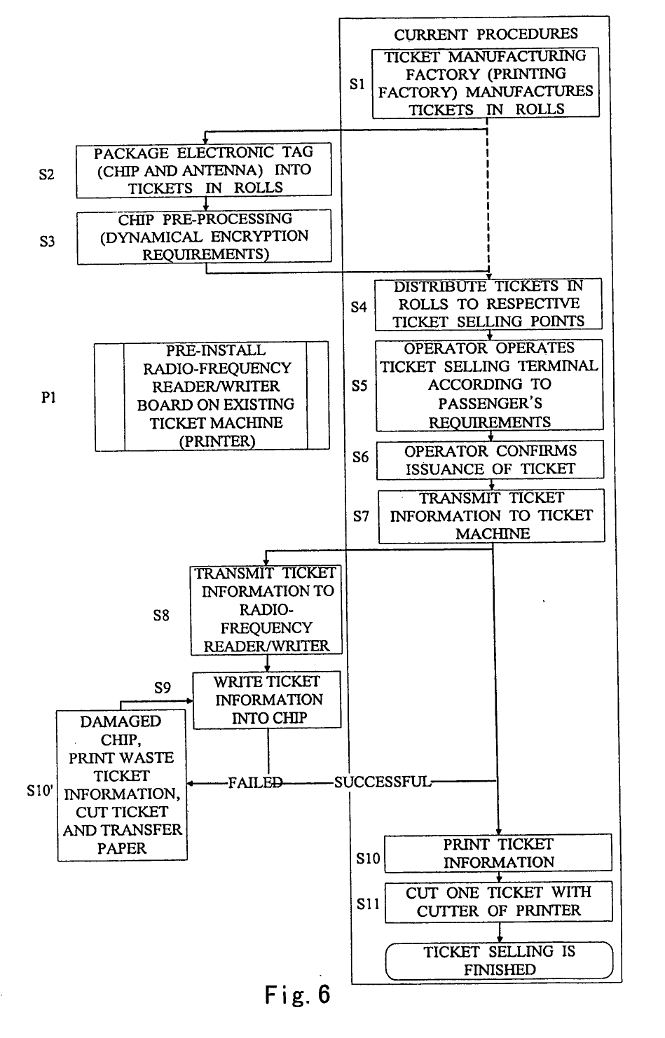

FIG. 6 shows the ticket making and selling flow of the electronic tickets according to the present invention. Next, referring to FIG. 6, the ticket making and selling flow of the electronic tickets according to the present invention is described. In Step S1, the paper media for producing the paper tickets in rolls are manufactured. In Step S2, the chips and the antennas are packaged into the paper media to form the electronic tickets in rolls which have the same appearance as that of the conventional tickets. The above two steps are performed simultaneously in the packaging factory. In Step S3, the chips of the electronic tickets in rolls are preprocessed to write the dynamic keys therein. In Step S4, according to conventional ticket managing flow, the tickets in rolls are distributed to respective ticket selling point. In Step S5, when a passenger purchase his/her ticket, the operator operates the ticket selling software terminal according to the passenger's requirements to select information such as the passenger's required train number, time, departure station, destination station, seat (sleeper) number and the like. In Step S6, after the passenger's confirmation, the issuance of the ticket is confirmed by pressing ENTER. In Step S7, the ticket selling software terminal transmits the ticket information to the ticket machine. In Step S8, the ticket information is firstly transmitted to the radio-frequency reader/writer built-in the ticket machine (P1). In Step S9, the radio-frequency reader/writer writes the information into the chip buried in the ticket. If the writing to the chip is successful, then in Step S10, the ticket machine prints the ticket information. If the writing to the chip is failed due to some reasons such as the damage of the chip, then in Step S10′, waste ticket information is printed, the waste ticket is cut, and the paper is transferred. For the next blank ticket, the writing to the chip according to Step S9 is re-performed until it is successful. In Step S11, it is cut with an electrical cutter, and the issuance of one electronic ticket is finished. The entire procedure is completely the same as before for the operator and the passenger, that is to say, the operator does not need to be trained, and the ticket selling and managing systems remain unchanged. That is the spirit of the railway ticket compatible techniques and methods according to the present invention.

The key points why the electronic ticket according to the present invention is highly compatible with the existing ticket system are that:
1) in the existing rolled tickets printing stage (the printing or packaging factor of the railway department), the RFID chips and antennas (the antennas can be printed with the conductive ink) are packaged into respective tickets in rolls in advance;
2) the appearance of the tickets in rolls distributed to respective selling points has no difference with that of prior art;
3) the radio-frequency reader/writer board is added into the existing ticket printer (ticket machine), the volume of which is not larger than 10 cm*10 cm, and the cost of which is of the order of hundreds RMB, the adoption can be easily performed with little maintenance cost, and the operators feel no changes;
4) during the selling of the tickets, while invoking the printing command to print the ticket information, the terminal software also writes the same information into the chip pre-buried in the rolled tickets through the radio-frequency reader/writer board, and the duration of the writing procedure is far less than 1 second without any manual intervention of the operator;
5) neither are the existing ticket selling software and mechanism changed, nor is the current ticket managing system changed;
6) the electronic tickets of the present invention are also supplied in rolls no needs for consideration of the ticket counting, relieve for boxed tickets;
7) the printer and the writer device can be integrated or separated; and
8) the radio-frequency reader/writer board is pre-installed in a newly manufactured printer.

In addition to the functions of automatic fare collection, high anti-counterfeiting and supporting for informatization as other hard-card RFID techniques or recycled electronic tickets, the high compatibility of the present invention with the existing ticket system also exists in the following aspects:
it is still a disposable paper ticket and the observed information remains unchanged;
it is still supplied in rolls for facilitating the operator's relieve;
it still uses the existing ticket selling devices, whereas the other schemes need to replace the current ticket selling machines, and currently, there are nearly 20 thousand ticket selling machines in the country;
the existing ticket selling software may not changed, only if further invokes a reader/writer driver while invoking the printing;
the existing ticket managing system remains unchanged;
the operators do not need to be trained since the operations are identical as before; and
the passengers still use the ticket as the invoice.

The paper-based electronic tickets according to the present invention advantageously complement the railway ticket selling and managing systems, and can be well merged with the existing system in the premises of not changing the system selling software and the ticket managing system and not influencing the existing ticket selling and managing systems, so as to achieve the close loop management for the railway automatic fare collection.

We suppose two stages for using the RFID techniques in the railway tickets:

First stage: In the premises of not influencing the existing ticket selling and managing systems, the close loop operation and effective anti-counterfeiting of the railway fare collection are achieved. For matching with the existing ticket selling mechanism, the electronic tickets are also supplied in rolls without considerations about the ticket counting of the boxed tickets. As compared with the entire ticket manufacturing and selling procedures of the prior art, only two steps are added, one is to package the electronic tags in the rolled tickets before printing the rolled tickets, and the other is to write data into the electronic tags after tickets selling and printing (the printer and the writing device can be integrated or separated, and the duration for writing data is less than 1 second). Thus, the ticket selling software and mechanism are not changed. Additionally, the existing ticket managing system is not changed either.
Second stage: With the aids of the powerful functions of the RFID techniques, various operations of the railway passenger transportation may be achieved step by step to enhance the informatization. Personal and various services can be provided to the passengers, such as single-trip electronic ticket, round-trip electronic ticket, season ticket for the inter-city passengers, rewards, ticket electronic wallet function and the like. The future electronic ticket can also used for groat consumes, for example, the passengers may purchase goods in the station shops with the payment amounts stored in the tickets. It will not only promote the other services of the railway system, but also increase the passengers' admissions to the conveniences and humanizations of the railway transportations, so as to improve the passengers' loyalties to the railway transportations.

Although the present invention is illustrated with the preferred embodiments thereof, it will be understood by those skilled in the art that the present invention may be modified, substituted and changed without departing from the spirits and scopes of the present invention. Therefore, the present invention is not intended to be limited by the aforementioned embodiments but only defined by the following claims and the equivalents thereof.

What is claimed is:

1. An electronic ticket compatible with the existing railway paper tickets, which comprises two layers of paper media where an antenna and a chip are buried in advance and is characterized in that:
dynamic encryption information is written into said chip in advance and has a check code associated with a serial number for anti-counterfeiting;
at a ticket selling terminal, ticket information will be written into said chip, and such ticket information in said chip can be rewritten many times; and
said antenna is used for receiving RF signals and transmitting them to said chip.

2. The electronic ticket according to claim 1, wherein:
a check-in bit is provided in the data stored in said chip for preventing repeated check-in.

3. The electronic ticket according to claim 2, wherein:
said antenna is formed by printing conductive ink on said paper media.

4. The electronic ticket according to claim 1, wherein:
said antenna is formed by printing conductive ink on said paper media.

5. A method for producing an electronic ticket compatible with the existing railway paper tickets, which comprises the steps of:
printing ticket information on a first layer of paper medium;
burying an antenna and a chip in a second layer of paper medium;
writing dynamic encryption information in said chip in advance, and this information having a check code associated with a serial number for anti-counterfeiting;
when selling the ticket, writing the ticket information into said chip, and such ticket information in said chip being able to be rewritten many times; and
when checking-in, receiving by said antenna an RF signal emitted from a check-in apparatus and transmitting it to said chip to verifying the authenticity of said ticket.

6. The method according to claim 5, further comprising:
providing a check-in bit in the data stored in said chip for preventing repeated check-in.

7. The method according to claim 6, wherein:
said antenna is formed by printing conductive ink on said paper media.

8. The method according to claim 5, wherein:
said antenna is formed by printing conductive ink on said paper media.
